(19) United States
(12) Patent Application Publication
(10) Pub. No.: US 2024/0396622 A1
(43) Pub. Date: Nov. 28, 2024

(54) CONTROL APPARATUS, COMMUNICATION NODE, AND METHODS THEREOF

(71) Applicant: NEC Corporation, Tokyo (JP)

(72) Inventors: Kazushi Sugyo, Tokyo (JP); Masakazu Ono, Tokyo (JP)

(73) Assignee: NEC Corporation, Tokyo (JP)

(21) Appl. No.: 18/659,194

(22) Filed: May 9, 2024

(30) Foreign Application Priority Data
May 22, 2023 (JP) 2023-083698

(51) Int. Cl. H04B 7/185; H04W 40/02

(52) U.S. Cl. CPC H04B 7/18513; H04W 40/02

(57) ABSTRACT

A control apparatus receives a request for a resource reservation in a non-terrestrial network (NTN) for a path from a first node to a second node that passes through a terrestrial network (TN) and the NTN. In response to the request, the control apparatus transmits a response indicating acceptance of the resource reservation without waiting for resources of a first partial path in the NTN to actually be reserved for the path. After one or more links have been established in the NTN and the resources for the first partial path have been reserved, the control apparatus controls the concatenation of the first partial path with a second partial path for which resources have previously been reserved in the TN.

### INCORPORATION BY REFERENCE

This application is based upon and claims the benefit of priority from Japanese patent application No. 2023-083698, filed on May 22, 2023, the disclosure of which is incorporated herein in its entirety by reference.

### TECHNICAL FIELD

The present disclosure relates to communication networks, and in particular to resource reservation for a path traversing multiple networks, including a non-terrestrial network.

### BACKGROUND ART

A Non-Terrestrial Network (NTN) is a network, or segments of a network, that utilizes one or both of airborne and spaceborne vehicles or platforms, each equipped with a transparent or regenerative repeater, relay node, or base station. Specifically, an NTN utilizes communications satellites, High Altitude Platform Stations (HAPS), unmanned aerial vehicles, or manned aircraft, or any combination of these. Communications satellites include Geostationary Earth Orbit (GEO) satellites, Non-Geostationary Orbit (NGSO) satellites, or both. GEO satellites orbit at an altitude of 35,786 km above the Earth's equator. NGSO satellites include Low-Earth orbit (LEO) satellites and Medium-Earth orbit (MEO) satellites. LEO satellites typically orbit closer to the Earth at altitudes of 500 km to 2,000 km. MEO satellites typically orbit at altitudes of 5,000 km to 20,000 km.

The term “Terrestrial Network (TN)” is used in this specification to distinguish it from NTN. A TN is a network, or segments of a network, located on the surface of the earth. A TN may be a wired network, a wireless network, or a combination of both.

Patent Literature 1 discloses a mobile communication system that uses communication lines or resources (e.g., frequency bands) allocated by a Demand Assigned Multiple Access (DAMA) satellite communication system. Specifically, in Patent Literature 1, a management station of a mobile communication system requests a control station of a DAMA satellite communication system to allocate one or more reserved lines or resources. The reservation request sent by the management station includes a description representing the communication start and end times. In response to receiving the reservation request, the control station of the DAMA satellite communication system allocates one or more reserved lines or resources to the mobile communication system. The management station of the mobile communication system allocates resources within the allocated reserved satellite communication resources (e.g., frequency bands) to communication lines for mobile communication. The management station sends line configuration commands to radio base stations and mobile stations in the mobile communication system. Based on the line configuration commands, the base stations and mobile stations configure the lines. Then, when the communication start time is reached, the control station of the DAMA satellite communication system sends a start notification to the management station of the mobile communication system, instructing it to start communication for the reserved lines. The management station instructs the base stations to start communication based on the start notification. The base stations then transmit the communication start signal to the mobile stations through communication lines via communication satellites.

### PATENT LITERATURE

Patent Literature 1: JP 2011-130498 A

### SUMMARY

Communication nodes within an NTN include not only satellite gateways or hubs located on the ground or on the surface of the earth, but also airborne and spaceborne vehicles with mobility. In addition, the constellation (e.g., satellite constellation or HAPS constellation) formed by communication nodes within an NTN may be sparse and localized. Due to these characteristics, an NTN may not always be able to provide the resources necessary for communication between two communication nodes within the NTN. This can lead to difficulties in reserving resources for an end-to-end path from a first communication node to a second communication node that passes through an NTN and a TN. In particular, general resource reservation techniques or protocols assume a network that includes multiple communication nodes with established links between each other. In other words, general resource reservation techniques or protocols aim to reserve network resources that are already available at the time the reservation is made. Thus, if an NTN is included in an end-to-end path for which a resource reservation is attempted, the resource reservation for the end-to-end path may fail, for example, due to the unavailability of resources in the NTN at the time the reservation is attempted.

Incidentally, as mentioned above, in Patent Literature 1, the management station of the mobile communication system sends a reservation request indicating the communication start and end times to the control station of the DAMA communication system and receives an allocation of resources (e.g., frequency bandwidth) from the DAMA communication system. The management station of the mobile communication system then uses the allocated resources for access lines (i.e., NTN access) between base stations and mobile stations in the mobile communication system during the period defined by the communication start and end times. However, this technique disclosed in Patent Literature 1 does not provide a solution to the difficulty of reserving resources for an end-to-end path from a first communication node to a second communication node that passes through an NTN and a TN.

An example object to be achieved by example embodiments disclosed herein is to provide apparatuses, methods, and programs that contribute to facilitating reservation of resources for an end-to-end path from a first communication node to a second communication node that passes through an NTN and a TN. It should be noted that this object is merely one of the objects to be achieved by the example embodiments disclosed herein. Other objects or problems and novel features will become apparent from the following description and the accompanying drawings.

In a first aspect, a control apparatus is configured to receive a request for a resource reservation in an NTN for a path from a first node to a second node that passes through a TN and the NTN, from the first node, the second node, a communication node belonging to the path, a management node in the NTN, or another controller associated with the TN. The control apparatus is configured to, in response to the request, transmit a response indicating acceptance of the resource reservation without waiting for resources of a first partial path in the NTN to actually be reserved for the path. The control apparatus is configured to establish one or more links in the NTN and reserve resources for the first partial path. The control apparatus is further configured to control concatenation of the first partial path in the NTN with a second partial path for which resources have previously been reserved in the TN.

In a second aspect, a method performed by a control apparatus includes the steps of:
(a) receiving a request for a resource reservation in an NTN for a path from a first node to a second node that passes through a TN and the NTN, from the first node, the second node, a communication node belonging to the path, a management node in the NTN, or another controller associated with the TN;
(b) transmitting, in response to the request, a response indicating acceptance of the resource reservation without waiting for resources of a first partial path in the NTN to actually be reserved for the path;
(c) establishing one or more links in the NTN and reserving resources for the first partial path; and
(d) controlling concatenation of the first partial path in the NTN with a second partial path for which resources have previously been reserved in the TN.

In a third aspect, a communication node is configured to transmit a request for a resource reservation for a path from the communication node to another node or from the other node to the communication node that passes through a TN and an NTN, to a node belonging to the path, a first controller associated with the TN, or a second controller associated with the NTN. The communication node is configured to receive a response indicating acceptance of the resource reservation, which is returned without waiting for resources of a first partial path in the NTN to actually be reserved for the path. The communication node is further configured to, after receiving the response, receive a notification indicating that resource reservation for the path or the first partial path has actually been completed or that the path or the first partial path is available.

In a fourth aspect, a method performed by a communication node includes the steps of:
(a) transmitting a request for a resource reservation for a path from the communication node to another node or from the other node to the communication node that passes through a TN and an NTN, to a node belonging to the path, a first controller associated with the TN, or a second controller associated with the NTN;
(b) receiving a response indicating acceptance of the resource reservation, which is returned without waiting for resources of a first partial path in the NTN to actually be reserved for the path; and
(c) after receiving the response, receiving a notification indicating that resource reservation for the path or the first partial path has actually been completed or that the path or the first partial path is available.

In a fifth aspect, a control apparatus is configured to receive a request for a resource reservation in an NTN for a path from a first node to a second node that passes through a TN and the NTN, from the first node, the second node, a communication node belonging to the path, a management node in the NTN, or another controller associated with the TN. The control apparatus is configured to, in response to the request, transmit a response indicating acceptance of the resource reservation without waiting for resources of a first partial path in the NTN to actually be reserved for the path. The control apparatus is configured to transmit a notification to the first node, the second node, the communication node, the management node, the other controller, a communication node in the NTN, or any combination thereof, after the resources for the first partial path are actually reserved. The notification indicates that the resource reservation for the first partial path has actually been completed or that the first partial path is available.

In a sixth aspect, a method performed by a control apparatus includes the steps of:
(a) receiving a request for a resource reservation in an NTN for a path from a first node to a second node that passes through a TN and the NTN, from the first node, the second node, a communication node belonging to the path, a management node in the NTN, or another controller associated with the TN;
(b) transmitting, in response to the request, a response indicating acceptance of the resource reservation without waiting for resources of a first partial path in the NTN to actually be reserved for the path; and
(c) transmitting a notification to the first node, the second node, the communication node, the management node, the other controller, a communication node in the NTN, or any combination thereof, after the resources for the first partial path are actually reserved, the notification indicating that the resource reservation for the first partial path has actually been completed or that the first partial path is available.

In a seventh aspect, a program includes instructions (software codes) that, when loaded into a computer, cause the computer to perform the method according to the second, fourth, or sixth aspect described above.

### BRIEF DESCRIPTION OF DRAWINGS

The above and other aspects, features, and advantages of the present invention will become more apparent from the following description of certain example embodiments when taken in conjunction with the accompanying drawings, in which:

FIG. 1 shows an example configuration of a communication network or system according to one or more example embodiments;

FIG. 2 shows an example configuration of a communication network or system according to one or more example embodiments;

FIG. 3 shows an example configuration of a communication network or system according to one or more example embodiments;

FIG. 4 is a flowchart showing an example of the operation of a controller according to one or more example embodiments;

FIG. 5 is a flowchart showing an example of the operation of a controller according to one or more example embodiments;

FIG. 6 is a flowchart showing an example of the operation of a communication node according to one or more example embodiments;

FIG. 7 is a diagram illustrating an example of a resource reservation procedure according to one or more example embodiments;

FIG. 8 is a diagram illustrating an example of a resource reservation procedure according to one or more example embodiments;

FIG. 9 is a diagram illustrating an example of a resource reservation procedure according to one or more example embodiments;

FIG. 10 is a sequence diagram showing an example of a resource reservation procedure according to one or more example embodiments;

FIG. 11 is a sequence diagram showing an example of a resource reservation procedure according to one or more example embodiments;

FIG. 12 is a sequence diagram showing an example of a resource reservation procedure according to one or more example embodiments; and

FIG. 13 is a block diagram showing an example configuration of a controller according to one or more example embodiments.

### DETAILED DESCRIPTION

Specific example embodiments will be described hereinafter in detail with reference to the drawings. The same or corresponding elements are denoted by the same symbols throughout the drawings, and duplicated explanations are omitted as necessary for the sake of clarity.

The multiple example embodiments described below may be implemented independently or in combination, as appropriate. These example embodiments include novel features different from each other. Accordingly, these example embodiments contribute to attaining objects or solving problems different from one another and contribute to obtaining advantages different from one another.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

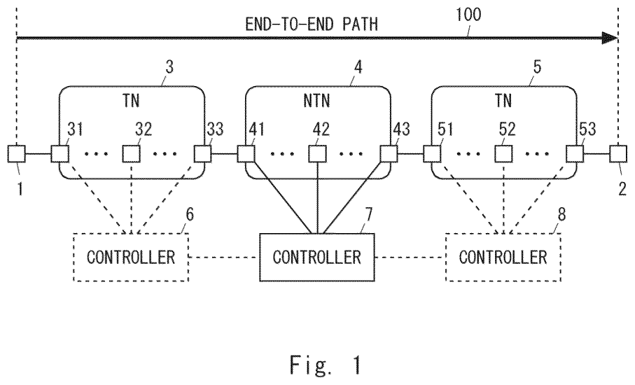

First, the configuration and operation of several elements common to a plurality of example embodiments will be described. FIG. 1 illustrates an example configuration of a communication network or system. In the example of FIG. 1, the communication network or system includes an end node 1, an end node 2, a terrestrial network (TN) 3, a non-terrestrial network (NTN) 4, a TN 5, and a controller 7. The communication network or system may include one or both of controllers 6 and 8. Each element (network function) shown in FIG. 1 may be implemented, for example, as a network element on dedicated hardware, as a software instance running on dedicated hardware, or as a virtualized function instantiated on an application platform.

The end node 1 communicates with the end node 2 via an end-to-end path 100 through the TN 3, NTN 4, and TN 5. Depending on specific implementations or use cases, the end node 1 may be referred to as a source node or an ingress node. Similarly, the end node 2 may be referred to as a destination node or an egress node. In the example in FIG. 1, the end-to-end path 100 is a one-way path from the end node 1 to the end node 2, but this is only an example. The end-to-end path 100 can be a bidirectional path that allows bidirectional communication between the end nodes 1 and 2. In other words, the end-to-end path 100 may be a combination of a one-way path from the end node 1 to the end node 2 and a one-way path in the opposite direction from the end node 2 to the end node 1. These two one-way paths in opposite directions may pass through different routes.

The TN 3 includes boundary nodes 31 and 33. The boundary node 31 provides a link or interface to the end node 1. The boundary node 33 provides a link or interface to the NTN 4 (or a boundary node 41). The TN 3 may or may not include one or more intermediate nodes 32. The boundary node 31 and the boundary node 33 are communicatively connected directly or through one or more intermediate nodes 32. Each of the links or interfaces connecting adjacent communication nodes within the TN 3 and between the TN 3 and the NTN 4 may be a wired link or a wireless link. The network topology of the TN 3 is not particularly restricted. In one example, each of the communication nodes 31 to 33 in the TN 3 may be a switch, a router, or a label switching node. Additionally or alternatively, the communication nodes 31 to 33 in the TN 3 may include cellular access nodes, i.e., base stations (e.g., Long-Term Evolution (LTE) base stations or 5G New Radio (NR) base stations) and radio terminals (e.g., LTE or 5G NR User Equipments (UEs)). The communication nodes 31 to 33 in the TN 3 may include core network nodes (e.g., Serving Gateways (SGWs), Packet Data Network Gateway (PGW), or User Plane Function (UPF)) of a cellular communication system.

The controller 6 can be used to manage nodes in the TN 3. The controller 6 may control resource reservations in the TN 3. Additionally or alternatively, resource reservations in the TN 3 may be performed by exchanging control packets between the boundary node 31, the boundary node 33, and one or more intermediate nodes 32. In this case, it may not be necessary to use the controller 6. A resource reservation may be a reservation of a route for a path between the boundary node 31 and the boundary node 33. The reservation of the route may include a reservation of computing and memory resources of communication nodes on the route. Additionally or alternatively, a resource reservation may be a reservation of a path with guaranteed quality of service (QOS) between the boundary node 31 and the boundary node 33. The guaranteed QoS may be, for example, bandwidth, bit rate, latency (or end-to-end delay), jitter, or packet loss rate, or any combination thereof. The controller 6 may include one or more computer systems.

The NTN 4 includes boundary nodes 41 and 43. The boundary node 41 provides a link or interface to the TN 3 (or the boundary node 33). The boundary node 43 provides a link or interface to the TN 5 (or a boundary node 51). The NTN 4 may or may not include one or more intermediate nodes 42. The boundary node 41 and the boundary node 43 are communicatively connected directly or through one or more intermediate nodes 42. Each of the links or interfaces connecting adjacent communication nodes within the NTN 4, between the NTN 4 and the TN 3, and between the NTN 4 and the TN 5 may be a wired link or a wireless link.

Specifically, each communication node in the NTN 4 can be an airborne vehicle or platform, or a spaceborne vehicle or platform, equipped with a transparent or regenerative repeater, a relay node, or a base station. More specifically, the NTN 4 may use communications satellites, HAPS, unmanned or manned aircraft, or any combination thereof. Communications satellites may include GEO, MEO, or LEO satellites, or any combination thereof. In addition, the NTN 4 may include two or more nodes (e.g., NTN gateways) located on the ground or near the earth's surface, which may provide wired links or interfaces. The network topology of the NTN 4 is not particularly restricted.

The Controller 7 is used to manage nodes in the NTN 4. The Controller 7 controls resource reservations in the NTN 4. In addition, resource reservations in the NTN 4 may be performed by exchanging control packets between the boundary node 41, the boundary node 43, and one or more intermediate nodes 42. A resource reservation may be a reservation of a route for a path between the boundary node 41 and the boundary node 43. The reservation of the route may include a reservation of computing and memory resources of communication nodes on the route. Additionally or alternatively, a resource reservation may be a reservation of a path with guaranteed Qos between the boundary node 41 and the boundary node 43. The guaranteed QoS may be, for example, bandwidth, bit rate, latency (or end-to-end delay), jitter, or packet loss rate, or any combination thereof. The controller 7 may include one or more computer systems. In some implementations, the controller 7 may manage or obtain trajectory or flight path information of airborne or spaceborne vehicles in the NTN 4 and predict a future constellation based on that information. Alternatively, the controller 7 may receive a future constellation from other controllers or systems. The controller 7 may then determine whether to accept or reject a resource reservation for a future time based on the future constellation.

The TN 5 includes boundary nodes 51 and 53. The boundary node 51 provides a link or interface to the NTN 4 (or the boundary node 43). The boundary node 53 provides a link or interface to the end node 2. The TN 5 may or may not include one or more intermediate nodes 52. The boundary node 51 and the boundary node 53 are communicatively connected directly or through one or more intermediate nodes 52. Each of the links or interfaces connecting adjacent communication nodes within the TN 5 and between the TN 5 and the NTN 4 may be a wired link or a wireless link. The network topology of the TN 5 is not particularly restricted.

The controller 8 can be used to manage nodes in the TN 5. The controller 8 may be combined or integrated with the controller 6 for the TN 3. The controller 8 may control resource reservations in the TN 5. Additionally or alternatively, resource reservations in the TN 5 may be performed by exchanging control packets between the boundary node 51, the boundary node 53, and one or more intermediate nodes 52. In this case, it may not be necessary to use the controller 8. A resource reservation may be a reservation of a route for a path between the boundary node 51 and the boundary node 53. The reservation of the route may include a reservation of computing and memory resources of communication nodes on the route. Additionally or alternatively, a resource reservation may be a reservation of a path with guaranteed QoS between the boundary node 51 and the boundary node 53. The guaranteed QoS may be, for example, bandwidth, bit rate, latency (or end-to-end delay), jitter, or packet loss rate, or any combination thereof. The controller 8 may include one or more computer systems.

In the configuration example in FIG. 1, the end node 1 may be a node belonging to the TN 3. In this case, the boundary node 31 may not be present or may simply be referred to as a communication or intermediate node. Similarly, the end node 2 may be a node belonging to the TN 5. In this case, the boundary node 53 may not exist or may simply be referred to as a communication or intermediate node.

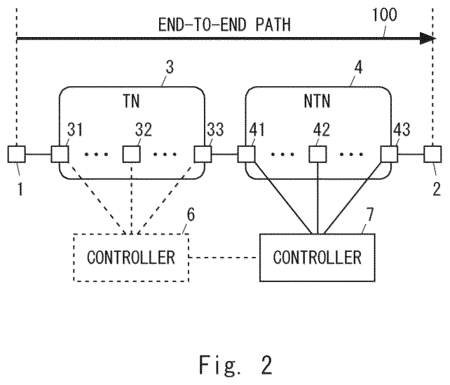

FIG. 2 shows another example of a communication network or system configuration. Compared to FIG. 1, the TN 5 is omitted in FIG. 2. The end node 1 communicates with the end node 2 via an end-to-end path 100 through the TN 3 and the NTN 4. The boundary node 43 of the NTN 4 provides a link or interface to the end node 2. The configuration, function, and operation of each element shown in FIG. 2 is the same as described for the corresponding element with respect to FIG. 1. In the configuration example in FIG. 2, the end node 1 may be a node belonging to the TN 3. In this case, the boundary node 31 may not be present or may simply be referred to as a communication or intermediate node. Similarly, the end node 2 may be a node belonging to the NTN 4. In this case, the boundary node 43 may not exist or may simply be referred to as a communication or intermediate node.

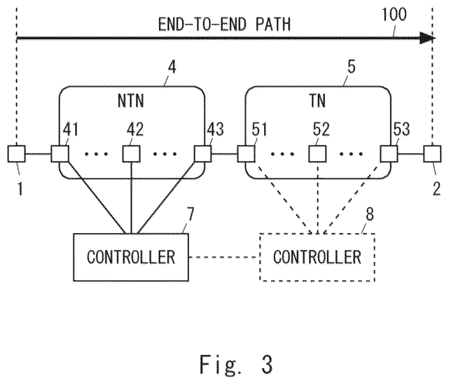

FIG. 3 shows another example of a communication network or system configuration. Compared to FIG. 1, the TN 3 is omitted in FIG. 3. The end node 1 communicates with the end node 2 via the end-to-end path 100 through the NTN 4 and the TN 5. The boundary node 41 of the NTN 4 provides a link or interface to the end node 1. The configuration, function, and operation of each element shown in FIG. 3 is the same as described for the corresponding element with respect to FIG. 1. In the configuration example in FIG. 3, the end node 1 may be a node belonging to the NTN 4. In this case, the boundary node 41 may not be present or may simply be referred to as a communication or intermediate node. Similarly, the end node 2 may be a node belonging to the TN 5. In this case, the boundary node 53 may not exist or may simply be referred to as a communication or intermediate node.

As described above, in the communication networks or systems shown in FIGS. 1 to 3, each communication node in the NTN 4 may be an airborne or spaceborne vehicle or platform with mobility. In addition, the constellation (e.g., satellite constellation or HAPS constellation) formed by multiple communication nodes within the NTN 4 may be sparse and localized. Due to these characteristics, the NTN 4 may not always be able to provide a communication path between the boundary node 41 and the boundary node 43 within the NTN 4 or the resources required for that communication path. The following example embodiments provide a resource reservation method or procedure for the end-to-end path 100 that takes into account these features of the NTN 4. In other words, the following example embodiments provide improvements to facilitate reserving resources for the end-to-end path 100 from the end node 1 to the end node 2 through the NTN 4 and one or more TNs (e.g., TNs 3 and 5).

### First Example Embodiment

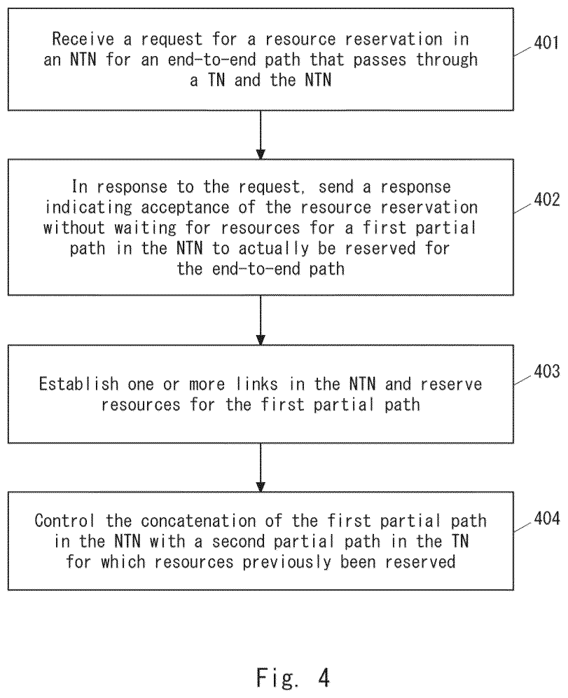

An example configuration of a communication network or system according to this example embodiment may be similar to any of the multiple configuration examples described with reference to FIGS. 1 to 3. FIG. 4 shows an example of the operation of the controller 7 associated with the NTN 4. In step 401, the controller 7 receives a request for a resource reservation in the NTN 4 for the end-to-end path 100 that is from the end node 1 to the end node 2 and passes through the NTN 4 and a TN (e.g., one or both of the TN 3 and the TN 5). Specifically, the controller 7 receives the request from the end node 1, the end node 2, any communication node belonging to the end-to-end path 100 (e.g., the boundary node 41 or 43), a management node in the NTN 4, or the controller 6 or 8 associated with the TN 3 or 5.

The request of step 401 may include a timeliness requirement indicating by when the resources of the end-to-end path 100 need to be secured. The timeliness requirement may indicate a future time or period of time when the end-to-end path 100 is needed. The controller 7 may determine whether or not to accept the request based on the timeliness requirement. If the resources for a partial path in the NTN 4 are available by the time or period of time requested in the timeliness requirement, the controller 7 may accept the request. Otherwise, the controller 7 may reject the request.

The request of step 401 may include any other requirements regarding the end-to-end path 100. For example, the request may specify routing information for the end-to-end path 100. The routing information may explicitly indicate identifiers or addresses of one or more communication nodes included in the route of the end-to-end path 100. The request may indicate QoS requirements (e.g., one or both of requested throughput and latency) for the end-to-end path 100. The controller 7 may determine whether to accept or reject the request based further on these other requirements.

In step 402, the controller 7 transmits a response indicating acceptance of the resource reservation in response to the request of step 401, without waiting for the resources of a first partial path in the NTN 4 to actually be reserved for the end-to-end path 100. In the configuration examples described with reference to FIGS. 1 to 3, the first partial path corresponds to a path from the boundary node 41 to the boundary node 43, either directly or through one or more intermediate nodes 42. The controller 7 may send the response of step 402 to the sender of the request of step 401.

The response of step 402 may indicate that the resource reservation in the NTN 4 for the end-to-end path 100 has been accepted, but not yet completed. The response may cause the resource reservation for the end-to-end path 100 to be provisionally completed.

Specifically, in the configuration examples shown in FIGS. 1 and 2, the response of step 402 may cause completion of the resource reservation of a second partial path in the TN 3 between the end node 1 and the NTN 4. The controller 6 associated with the TN 3 may complete the resource reservation in the TN 3 in response to receiving the response of step 402 from the controller 7. The controller 6 may then inform the end node 1 of the provisional completion of the resource reservation for the end-to-end path 100, either directly or through any other node (e.g., the boundary node 31). Alternatively, the boundary node 33 in the TN 3 may receive a response packet based on the response of step 402 from the NTN 4 (e.g., the boundary node 41 or another management node) and forward the response packet towards the end node 1. The response packet may inform the end node 1 of the provisional completion of the resource reservation for the end-to-end path 100.

In the configuration example shown in FIG. 3, the controller 7 may send the response of step 402 to the end node 1 via the boundary node 41 or another management node in the NTN 4.

In the configuration examples shown in FIGS. 1 and 3, before or after step 402, or in parallel with step 402, the controller 7 may operate as follows to assist in reserving resources in the TN 5 for the end-to-end path 100. The controller 7 may transmit a request for resource reservation for a second partial path in the TN 5 to a node in the TN 5 (e.g., the boundary node 51) or to the controller 8 associated with the TN 5, either directly or through a node in the NTN 4 (e.g., the boundary node 43 or another management node). The controller 7 may then receive a response indicating the completion of the resource reservation within the TN 5. Subject to receiving the response indicating completion of the resource reservation within the TN 5, the controller 7 may transmit the response of step 402, e.g., the response indicating provisional completion of the resource reservation for the first partial path in the NTN 4.

Returning to FIG. 4, in step 403, the controller 7 establishes one or more links in the NTN 4 and actually reserves resources for the first partial path in the NTN 4. Step 403 may be initiated after step 402 or in parallel with step 402. The controller 7 may establish one or more links in the NTN 4 and reserve resources for the first partial path in the NTN 4, while satisfying the desired timeliness requirement for the end-to-end path 100. The controller 7 may request one or more control nodes in the NTN 4 to establish one or more links in the NTN 4. The controller 7 may request one or more control nodes in the NTN 4 to reserve resources in the established one or more links in the NTN 4.

In step 404, the controller 7 controls the concatenation of the first partial path in the NTN 4 with one or two second partial paths for which the resources have previously been reserved in one or both of the TNs 3 and 5. In other words, the controller 7 completes the overall resource reservation for the end-to-end path 100 by coupling or concatenating the first partial path and the second partial path.

Specifically, the controller 7 may instruct one or more nodes in the NTN 4 (e.g., the boundary nodes 41 and 43, or one or more other management nodes) to perform a route switch to concatenate the first partial path with the second partial path. Additionally or alternatively, the controller 7 may instruct one or more communication nodes belonging to the end-to-end path 100 to perform a route switch to concatenate the first partial path with the second partial path, either directly or through any node in the NTN 4. The one or more communication nodes belonging to the end-to-end path 100 may be the end node 1, the end node 2, the boundary node 43, the boundary node 51, or any combination thereof. Additionally or alternatively, the controller 7 may instruct one or both of the controllers 6 and 8 associated with the TNs 3 and 5 to perform a route switch to concatenate the first partial path with the second partial path.

The controller 7 may transmit a notification indicating that the resource reservation for the first partial path has actually been completed or that the first partial path is available. This notification may be sent to the end node 1, the end node 2, a communication node belonging to the end-to-end path 100, a management node in the NTN 4, the controller 6, the controller 8, or any combination thereof, either directly or through any node in the NTN 4. The notification may cause a node in the TN 3, or a node in the TN 5, or both, to perform a route switch to concatenate the second partial path with the first partial path.

According to the operation described with reference to FIG. 4, the controller 7 provisionally completes the resource reservation within the NTN 4 for the end-to-end path 100 that passes through the NTN 4 and one or both of the TNs 3 and 5. The controller 7 then establishes one or more links within the NTN 4 and actually reserves resources for the first partial path within the NTN 4. Thereafter, the controller 7 controls the concatenation of the first partial path in the NTN 4 with one or two second partial paths for which resources have previously been reserved in one or both of the TNs 3 and 5. Such operation of the controller 7 helps to facilitate the reservation of resources for the end-to-end path 100 which passes through the NTN 4 and one or more TNs (e.g., TNs 3 and 5) from the end node 1 to the end node 2.

### Second Example Embodiment

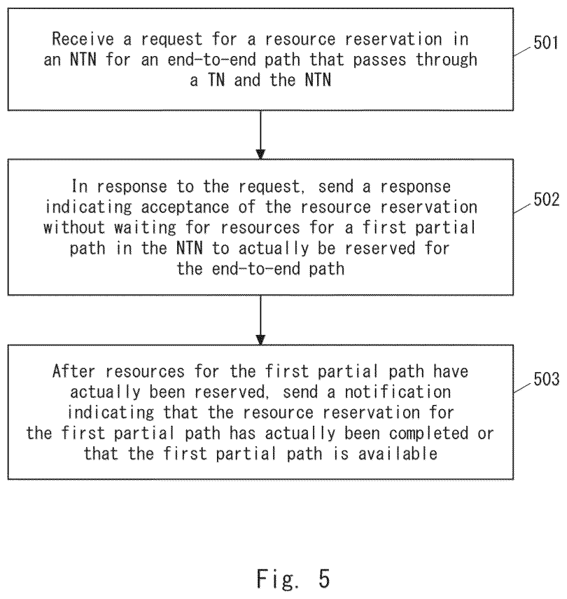

An example configuration of a communication network or system according to this example embodiment may be similar to any of the multiple configuration examples described with reference to FIGS. 1 to 3. FIG. 5 shows another example of the operation of the controller 7 associated with the NTN 4. Step 501 is the same as step 401 in FIG. 4. Specifically, in step 401, the controller 7 receives a request for a resource reservation in the NTN 4 for the end-to-end path 100 that is from the end node 1 to the end node 2 and passes through the NTN 4 and a TN (e.g., one or both of the TN 3 and the TN 5). Specifically, the controller 7 receives the request from the end node 1, the end node 2, any communication node belonging to the end-to-end path 100 (e.g., the boundary node 41 or 43), a management node in the NTN 4, or the controller 6 or 8 associated with the TN 3 or 5.

The request of step 501 may include a timeliness requirement indicating by when the resources of the end-to-end path 100 need to be secured. The timeliness requirement may indicate a future time or period of time when the end-to-end path 100 is needed. The controller 7 may determine whether or not to accept the request based on the timeliness requirement. If the resources for a partial path in the NTN 4 are available by the time or period of time requested in the timeliness requirement, the controller 7 may accept the request. Otherwise, the controller 7 may reject the request.

The request of step 501 may include any other requirements regarding the end-to-end path 100. For example, the request may specify routing information for the end-to-end path 100. The routing information may explicitly indicate identifiers or addresses of one or more communication nodes included in the route of the end-to-end path 100. The request may indicate QoS requirements (e.g., one or both of requested throughput and latency) for the end-to-end path 100. The controller 7 may determine whether to accept or reject the request based further on these other requirements.

Step 502 is the same as step 402 in FIG. 4. Specifically, in step 502, the controller 7 transmits a response indicating acceptance of the resource reservation in response to the request of step 501, without waiting for the resources of a first partial path in the NTN 4 to actually be reserved for the end-to-end path 100. In the configuration examples described with reference to FIGS. 1 to 3, the first partial path corresponds to a path from the boundary node 41 to the boundary node 43, either directly or through one or more intermediate nodes 42. The controller 7 may send the response of step 502 to the sender of the request of step 501.

The response of step 502 may indicate that the resource reservation in the NTN 4 for the end-to-end path 100 has been accepted, but not yet completed. The response may cause the resource reservation for the end-to-end path 100 to be provisionally completed.

Specifically, in the configuration examples shown in FIGS. 1 and 2, the response of step 502 may cause completion of the resource reservation of a second partial path in the TN 3 between the end node 1 and the NTN 4. The controller 6 associated with the TN 3 may complete the resource reservation in the TN 3 in response to receiving the response of step 502 from the controller 7. The controller 6 may then inform the end node 1 of the provisional completion of the resource reservation for the end-to-end path 100, either directly or through any other node (e.g., the boundary node 31). Alternatively, the boundary node 33 in the TN 3 may receive a response packet based on the response of step 502 from the NTN 4 (e.g., the boundary node 41 or another management node) and forward the response packet towards the end node 1. The response packet may inform the end node 1 of the provisional completion of the resource reservation for the end-to-end path 100.

In the configuration example shown in FIG. 3, the controller 7 may send the response of step 502 to the end node 1 via the boundary node 41 or another management node in the NTN 4.

In the configuration examples shown in FIGS. 1 and 3, before or after step 502, or in parallel with step 502, the controller 7 may operate as follows to assist in reserving resources in the TN 5 for the end-to-end path 100. The controller 7 may transmit a request for resource reservation for a second partial path in the TN 5 to a node in the TN 5 (e.g., the boundary node 51) or to the controller 8 associated with the TN 5, either directly or through a node in the NTN 4 (e.g., the boundary node 43 or another management node). The controller 7 may then receive a response indicating the completion of the resource reservation within the TN 5. Subject to receiving the response indicating completion of the resource reservation within the TN 5, the controller 7 may transmit the response of step 502, e.g., the response indicating provisional completion of the resource reservation for the first partial path in the NTN 4.

Returning to FIG. 5, in step 503, the controller 7 transmits a notification indicating that the resource reservation for the first partial path has actually been completed or that the first partial path is available after the resources for the first partial path have actually been reserved in the NTN 4. This notification may be sent to the end node 1, the end node 2, a communication node belonging to the end-to-end path 100, a management node in the NTN 4, the controller 6, the controller 8, or any combination thereof, either directly or through any node in the NTN 4. The notification may cause a node in the TN 3, or a node in the TN 5, or both, to perform a route switch to concatenate the second partial path with the first partial path.

According to the operation described with reference to FIG. 5, the controller 7 provisionally completes the resource reservation within the NTN 4 for the end-to-end path 100 passing through the NTN 4 and one or both of the TNs 3 and 5. The controller 7 then sends a notification indicating that the resource reservation in the NTN 4 has actually been completed. Such operation of the controller 7 helps to facilitate the reservation of resources for the end-to-end path 100 which passes through the NTN 4 and one or more TNs (e.g., TNs 3 and 5) from the end node 1 to the end node 2.

### Third Example Embodiment

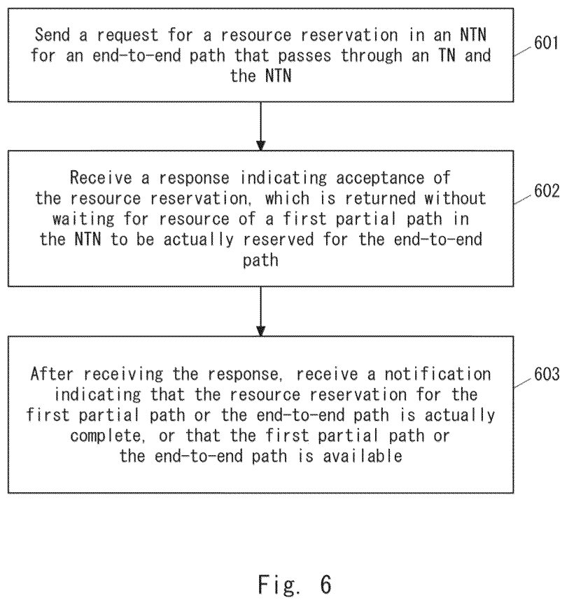

An example configuration of a communication network or system according to this example embodiment may be similar to any of the multiple configuration examples described with reference to FIGS. 1 to 3. FIG. 6 shows an example of an operation performed by the end node 1 or 2. In step 601, the end node 1 or 2 transmits a request for resource reservation for the end-to-end path 100 that is from the end node 1 to the end node 2 and passes through the NTN 4 and a TN (e.g., one or both of the TN 3 and the TN 5). Specifically, the end node 1 or 2 transmits the request to one of the communication nodes belonging to the end-to-end path 100 (e.g., the boundary nodes 31 or 53), to the controller 6 or 8 associated with the TNs 3 or 5, or to the controller 7 associated with the NTN 4.

The request of step 601 may include a timeliness requirement indicating by when the resources of the end-to-end path 100 need to be secured. The timeliness requirement may indicate a future time or period of time when the end-to-end path 100 is needed. The controller 7 of the NTN 4 may use this timeliness requirement to determine whether to accept or reject a request for a resource reservation for a partial path within the NTN 4. If the resources for a partial path in the NTN 4 are available by the time or period of time requested in the timeliness requirement, the controller 7 may accept the request. Otherwise, the controller 7 may reject the request.

The request of step 601 may include any other requirements regarding the end-to-end path 100. For example, the request may specify routing information for the end-to-end path 100. The routing information may explicitly indicate identifiers or addresses of one or more communication nodes included in the route of the end-to-end path 100. The request may indicate QoS requirements (e.g., one or both of requested throughput and latency) for the end-to-end path 100. The controller 7 associated with the NTN 4 may determine whether to accept or reject a reservation request for resources in the NTN 4 based further on these other requirements.

In step 602, the end node 1 or 2 receives a response indicating acceptance of the resource reservation, which is returned without waiting for resources of a first partial path in the NTN 4 to actually be reserved for the end-to-end path 100. The end node 1 or 2 may receive the response from any of the communication nodes belonging to the end-to-end path 100 (e.g., the boundary nodes 31 or 53), the controller 6 or 8 associated with the TNs 3 or 5, or the controller 7 associated with the NTN 4.

The response of step 602 may indicate that the resource reservation in the NTN 4 for the end-to-end path 100 has been accepted, but not yet completed. The response may indicate that the resource reservation for the end-to-end path 100 is provisionally complete. In response to receiving the response of step 602, the end node 1 or 2 may recognize that the resources for a second partial path in the TN (e.g., one or both of the TN 3 and the TN 5) of the end-to-end path 100 have actually been successfully reserved and prepared, while the resources for the first partial path in the NTN 4 have only been provisionally reserved and not yet actually prepared.

In step 603, after receiving the response of step 602, the end node 1 or 2 receives a notification that the resource reservation for the first partial path within the NTN 4 or for the end-to-end path 100 is actually complete, or that the first partial path or the end-to-end path 100 is available. The end node 1 or 2 may receive the notification from any of the communication nodes belonging to the end-to-end path 100 (e.g., the boundary nodes 31 or 53), the controller 6 or 8 associated with the TNs 3 or 5, or the controller 7 associated with the NTN 4. In response to receiving the notification, the end node 1 or 2 may recognize that the resources of the first partial path in the NTN 4 have actually been successfully reserved and prepared. In other words, in response to receiving the notification, the end node 1 or 2 may recognize that the entire resources of the end-to-end path 100, containing the first partial path, have actually been successfully reserved and prepared.

According to the operation described with reference to FIG. 6, one or both of the end nodes 1 or 2 recognizes that the resource reservation in the NTN 4 for the end-to-end path 100 is provisionally complete, and then recognizes that the resource reservation in the NTN 4 is actually complete. Such operation of one or both of the end nodes 1 or 2 helps to facilitate the reservation of resources for the end-to-end path 100 which passes through the NTN 4 and one or more TNs (e.g., TNs 3 and 5) from the end node 1 to the end node 2.

### Fourth Example Embodiment

An example configuration of a communication network or system according to this example embodiment may be similar to any of the multiple configuration examples described with reference to FIGS. 1 to 3. The following provides an example of a resource reservation procedure for the end-to-end path 100 from the end node 1 to the end node 2 through the NTN 4 and a TN (e.g., one or both of the TN 3 and the TN 5), using primarily the example configuration in FIG. 1. However, this procedure can also be applied to cases where the configuration examples shown in FIGS. 2 and 3 are used.

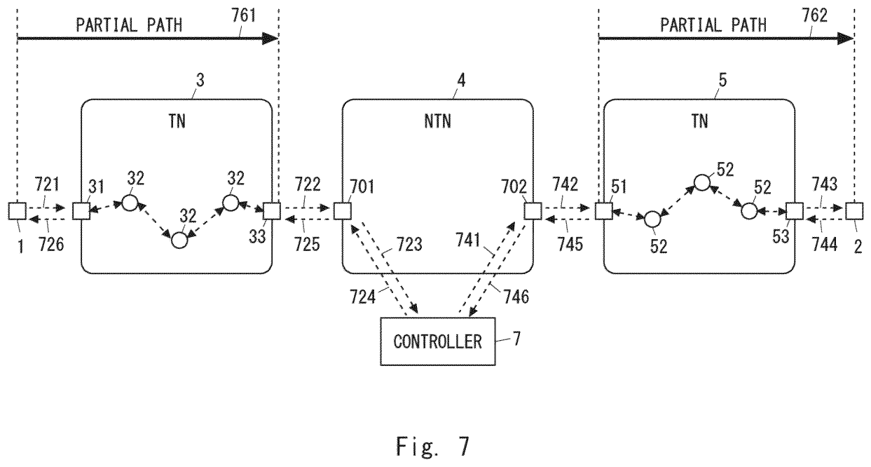

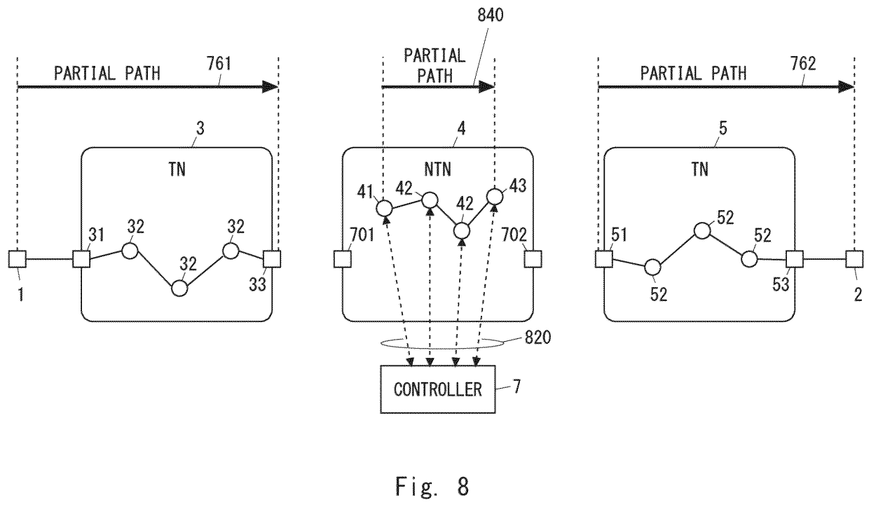

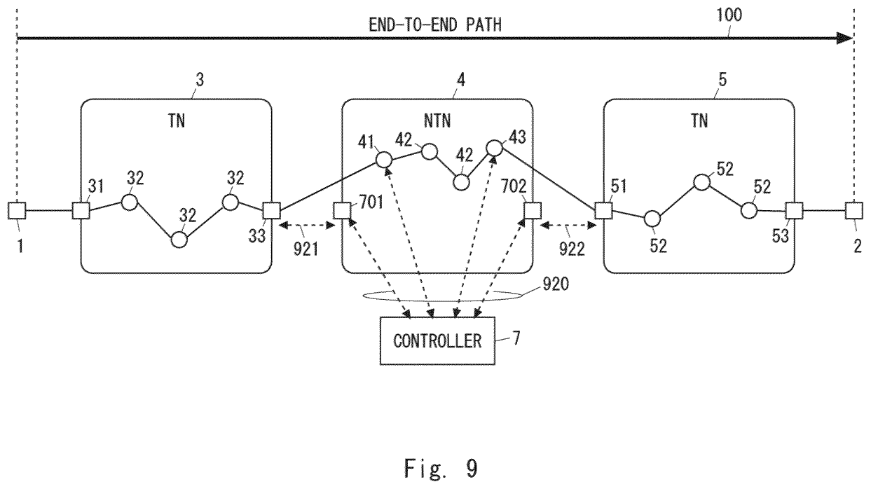

FIGS. 7 to 9 illustrate the three phases of a resource reservation for the end-to-end path 100. FIG. 7 shows the provisional completion phase of the resource reservation for the end-to-end path 100. FIG. 8 shows the link establishment and resource reservation phase within the NTN 4 for the end-to-end path 100. FIG. 9 shows the route switching phase to complete the end-to-end path 100.

In the provisional completion phase of the resource reservation, the resource reservation for one or more partial paths in the TN (referred to as second partial paths) included in the end-to-end path 100 is completed first, without waiting for the resource reservation for a partial path in the NTN 4 (referred to as the first partial path) to be completed. Referring to FIG. 7, the resource reservations for the two second partial paths, i.e., partial paths 761 and 762, are completed first.

In some implementations, the end node 1 sends a request 721 to the boundary node 31 of the TN 3 to reserve resources for the end-to-end path 100. The request 721 may include a timeliness requirement indicating by when the resources of the end-to-end path 100 need to be secured. The timeliness requirement may indicate a future time or period of time when the end-to-end path 100 is needed. The request 721 may include any other requirements regarding the end-to-end path 100. For example, the request 721 may specify routing information for the end-to-end path 100. The routing information may explicitly indicate identifiers or addresses of one or more communication nodes included in the route of the end-to-end path 100. The request 721 may indicate QoS requirements (e.g., one or both of requested throughput and latency) for the end-to-end path 100.

The request 721, or a control packet based on the request 721, is forwarded by the boundary node 31 to the boundary node 33. The boundary node 33 sends a request 722 to a management node 701 of the NTN 4 to reserve resources for the end-to-end path 100. The request 722 may include information items included in the request 721. The management node 701 sends a request 723 to the controller 7 to reserve resources for the end-to-end path 100. The request 723 may include information items included in the request 722.

In response to receiving the request 723, the controller 7 determines whether to accept or reject the request 723. The controller 7 may accept the request 723 if one or more of the requirements specified in the request 723 can be met. For example, if the resources for a first partial path in the NTN 4 can be made available by the time or period requested in the timeliness requirement included in the request 723, the controller 7 may accept the request 723. Otherwise, the controller 7 may reject the request 723.

If the controller 7 accepts the request 723, the controller 7 sends a response 724 to the management node 701 indicating acceptance of the resource reservation without waiting for the resource of the first partial path to actually be reserved for the end-to-end path 100 in the NTN 4. The response 724 may indicate that the resource reservation in the NTN 4 for the end-to-end path 100 has been accepted, but not yet completed. The response 724 may cause provisional completion of the resource reservation for the end-to-end path 100.

The management node 701 sends a response 725 to the boundary node 33 in response to receiving the response 724. The response 725 may include information items included in the response 724. The response 725, or a control packet based on the response 725, is forwarded by the boundary node 33 to the boundary node 31. The boundary node 31 sends a resource reservation response 726 for the end-to-end path 100 to the end node 1. The response 726 may include information items included in the response 724. Specifically, the response 726 may indicate that the resource reservation within the NTN 4 for the end-to-end path 100 has been accepted but not yet completed. The response 726 may indicate provisional completion of the resource reservation for the end-to-end path 100. In response to receiving the response 726, the end node 1 may recognize that the resources for the second partial paths 761 and 762 of the end-to-end path 100 have actually been successfully reserved and prepared, but that the resources for the first partial path within the NTN 4 have only been provisionally reserved and not yet actually prepared.

Before or after the transmission of the response 724, or in parallel with the transmission of the response 724, the controller 7 operates as follows to assist in reserving resources for the partial path 762 in the TN 5. The controller 7 sends a request 741 to a management node 702 of the NTN 4 to reserve resources for the partial path 762. The management node 702 may be the same as the management node 701. The request 741 may include the information items included in the request 723. The management node 702 sends a request 742 to the boundary node 51 in response to receiving the request 741. The request 742 may include information items included in the request 741. The request 742, or a control packet based on the request 742, is forwarded by the boundary node 51 to the boundary node 53. The boundary node 53 sends a request 743 to the end node 2. The request 743 may include information items included in the request 742. The end node 2 sends a response 744 to the boundary node 53. The response 744, or a control packet based on the response 744, is forwarded by the boundary node 53 to the boundary node 51. The boundary node 51 sends a response 745 to the management node 702. The management node 702 sends a response 746 to the controller 7. Based on receipt of the response 746, the controller 7 may recognize that the resource reservation for the partial path 762 in the TN 5 has been successfully completed. Transmission of the response 724 by the controller 7 may be performed in response to receipt of the response 746.

Referring now to FIG. 8, the link establishment and resource reservation phase within the NTN 4 for the end-to-end path 100 is described. In this phase, the controller 7 establishes one or more links within the NTN 4 and actually reserves resources for the first partial path 840 within the NTN 4. In some implementations, the controller 7 exchanges control signals or messages 820 with the boundary node 41, one or more intermediate nodes 42, and the boundary node 43 in the NTN 4. With the exchange of control signals or messages 820, the controller 7 may instruct the communication nodes 41 to 43 to establish one or more links and to actually reserve the resources of the first partial path 840. The exchange of control signals or messages for link establishment may also occur between the communication nodes 41 to 43.

Referring next to FIG. 9, the route switching phase for completing the end-to-end path 100 is described. In this phase, the controller 7 controls the first partial path 840 in the NTN 4 to be concatenated with the two second partial paths 761 and 762 whose resources have previously been reserved in the TNs 3 and 5, thereby completing the establishment or creation of the end-to-end path 100. In other words, the controller 7 completes the entire resource reservation for the entire end-to-end path 100 by combining the first partial path 840 and the second partial paths 761 and 762.

In some implementations, the controller 7 exchanges control signals or messages 920 with the boundary nodes 41 and 43 along with the management nodes 701 and 702. Specifically, the controller 7 may instruct the boundary node 41 to receive packets related to the end-to-end path 100 from the boundary node 33 of the TN 3. The controller 7 may instruct the boundary node 43 to send packets related to the end-to-end path 100 to the boundary node 51 in the TN 5. The controller 7 may request the management node 701 to send an instruction 921 to the boundary node 33 of the TN 3 to change the forwarding destination of packets related to the end-to-end path 100 to the boundary node 41. The controller 7 may request the management node 702 to send an instruction 922 to the boundary node 51 of the TN 5 to change the forwarding source of packets related to the end-to-end path 100 to the boundary node 43

The resource reservation method or procedure described with reference to FIGS. 7 to 9 may be modified in various ways. For example, the controller 6 associated with the TN 3 and the controller 8 associated with the TN 5 may be used. In this case, the controller 7 may exchange control messages with the controller 6 instead of signaling with the management node 701 shown in FIG. 7 and FIG. 9. Similarly, the controller 7 may exchange control messages with the controller 8 instead of signaling with the management node 702 shown in FIG. 7 and FIG. 9.

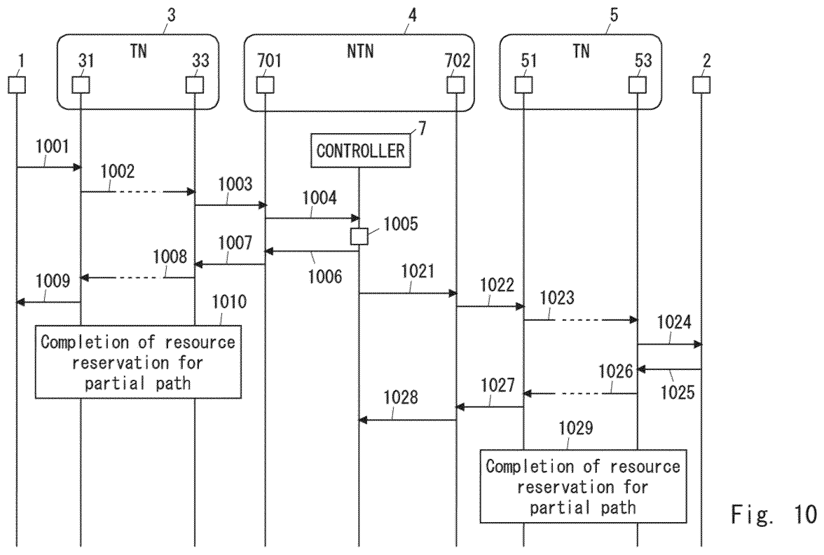

FIG. 10 illustrates an example of signaling in the provisional completion phase of resource reservation for the end-to-end path 100 described with reference to FIG. 7. Steps 1001 to 1004 correspond to the transmission of requests 721, 722, and 723 in FIG. 7. In step 1005, the controller 7 determines whether or not to accept the request for resource reservation in the NTN 4 for the end-to-end path 100. Steps 1006 to 1009 correspond to the transmission of responses 724, 725, and 726 in FIG. 7. In step 1010, the TN 3 completes the resource reservation for the partial path 761 in the TN 3.

Steps 1021 to 1024 correspond to the transmission of requests 741, 742, and 743 in FIG. 7. Steps 1025 to 1028 correspond to the transmission of responses 744, 745, and 746 in FIG. 7. In step 1029, the TN 5 completes the resource reservation for the partial path 762 in the TN 5. Steps 1021 to 1028 may be performed prior to step 1005 or prior to step 1006.

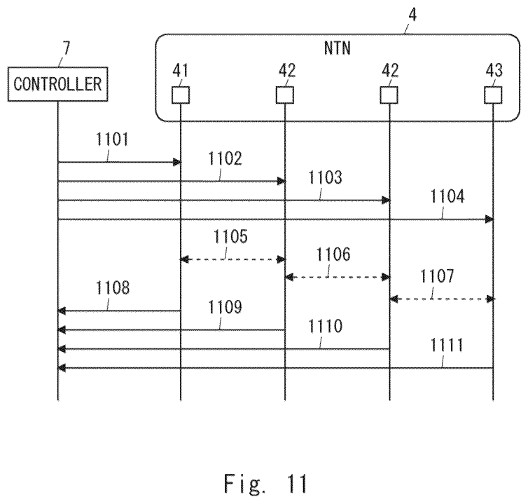

FIG. 11 shows an example of signaling in the link establishment and resource reservation phase in the NTN 4 for the end-to-end path 100, described with reference to FIG. 8. In steps 1101 to 1104, the controller 7 instructs the communication nodes 41 to 43 to establish one or more links and to actually reserve the resources of the first partial path 840. In steps 1105 to 1107, control signals or messages for establishing links may be exchanged between the communication nodes 41 to 43. In steps 1108 to 1111, the controller 7 receives responses from the communication nodes 41 to 43. These responses may indicate completion of the link establishment and resource reservation.

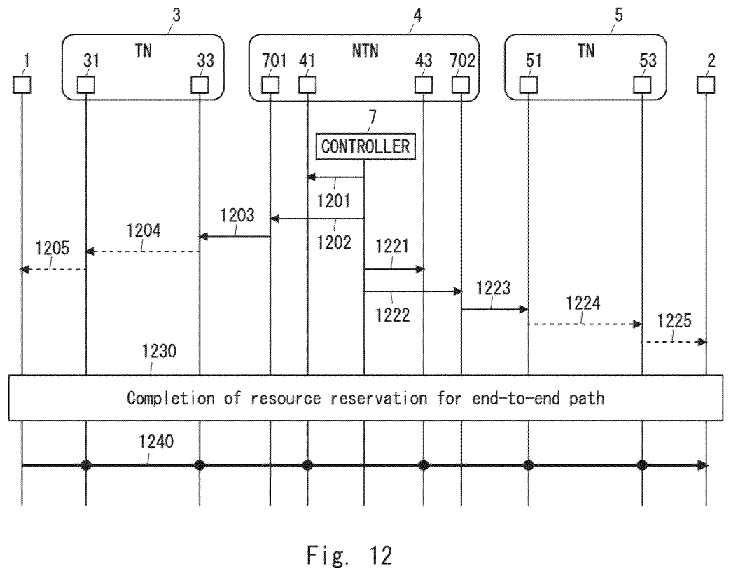

FIG. 12 illustrates an example of signaling in the route switching phase to complete the end-to-end path 100, described with reference to FIG. 9. In step 1201, the controller 7 instructs the boundary node 41 to receive packets related to the end-to-end path 100 from the boundary node 33 of the TN 3. In step 1202, the controller 7 requests the management node 701 to instruct the boundary node 33 to change the forwarding destination of packets related to the end-to-end path 100 to the boundary node 41. In step 1203, the management node 701 instructs the boundary node 33 to change the forwarding destination of packets related to the end-to-end path 100 to the boundary node 41.

In step 1204, the boundary node 33 may send a notification to the boundary node 31, either directly or through one or more intermediate nodes 32. In step 1205, the boundary node 31 may forward the received notification to the end node 1. The notification may indicate that the resource reservation for the first partial path 840 in the NTN 4 or for the end-to-end path 100 is actually complete, or that the first partial path 840 or the end-to-end path 100 is available.

In step 1221, the controller 7 instructs the boundary node 43 to forward packets related to the end-to-end path 100 to the boundary node 51 in the TN 5. In step 1222, the controller 7 requests the management node 702 to instruct the boundary node 51 to change the forwarding source of packets related to the end-to-end path 100 to the boundary node 43. In step 1223, the management node 702 instructs the boundary node 51 to change the forwarding source of packets related to the end-to-end path 100 to the boundary node 43.

In step 1224, the boundary node 51 may send a notification to the boundary node 53, either directly or through one or more intermediate nodes 52. In step 1225, the boundary node 53 may forward the received notification to the end node 2. The notification may indicate that the resource reservation for the first partial path 840 in the NTN 4 or for the end-to-end path 100 is actually complete, or that the first partial path 840 or the end-to-end path 100 is available.

In step 1230, the resource reservation for the entire end-to-end path 100 is actually completed. In step 1204, the end node 1 communicates with the end node 2 over the end-to-end path 100, which passes through the boundary nodes 31 and 33 of the TN 3, the boundary nodes 41 and 43 of the NTN 4, and the boundary nodes 51 and 53 of the TN 5.

The procedures or methods described in this example embodiment facilitate the reservation of resources for the end-to-end path that is from a first communication node to a second communication node and that passes through an NTN and a TN.

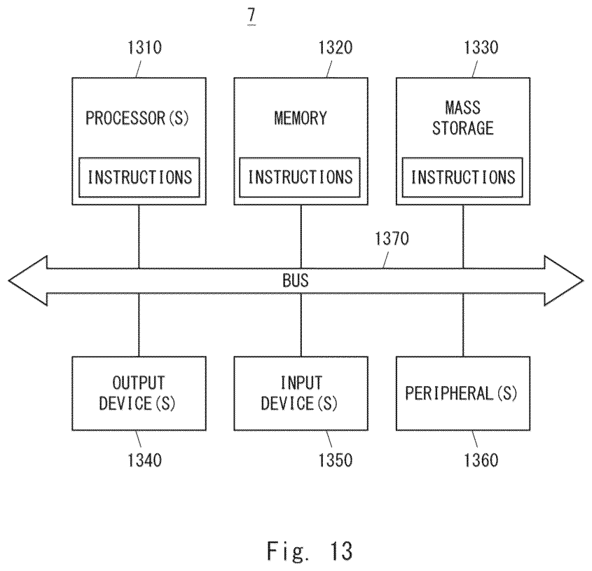

The following provides examples of the configuration of the controller 7 according to the above described example embodiments. The controllers 6 and 8 may also have a configuration similar to that of the controller 7 described below. FIG. 13 is a block diagram showing an example configuration of the controller 7. In the example in FIG. 13, the controller 7 is implemented as a computer system. The computer system includes one or more processors 1310, a memory 1320, and a mass storage 1330 that communicate with each other over a bus 1370. The one or more processors 1310 may include, for example, a Central Processing Unit (CPU) or a Graphics Processing Unit (GPU) or both. The computer system may include other devices such as one or more output devices 1340, one or more input devices 1350, and one or more peripherals 1360. The one or more peripherals 1360 may include a modem, or a network adapter, or any combination thereof.

One or both of the memory 1320 and the mass storage 1330 include a computer-readable medium storing a set of one or more instructions. These instructions may be partially or wholly located in memory in the one or more processors 1310. These instructions, when executed in the one or more processors 1310, cause the one or more processors 1310 to provide the functions of the controller 7 described in the above example embodiments.

As described using FIG. 13, each of the one or more processors in the controller 7 according to the example embodiments described above can execute one or more programs, containing a set of instructions, for causing a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, but not limitation, transitory computer readable media or communication media can include electrical, optical, acoustical, or other form of propagated signals.

An example advantage according to the above-described example embodiments is to facilitate reservation of resources for an end-to-end path from a first communication node to a second communication node that passes through an NTN and a TN.

The above-described example embodiments are merely examples of applications of the technical ideas obtained by the inventor. These technical ideas are not limited to the above-described example embodiments and various modifications can be made thereto.

For example, the whole or part of the example embodiments disclosed above can be described as, but not limited to, the following supplementary notes.

### Supplementary Note 1

A control apparatus comprising:
means for receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
means for transmitting, in response to the request, a response indicating acceptance of the resource reservation without waiting for resources of a first partial path in the non-terrestrial network to actually be reserved for the path;
means for establishing one or more links in the non-terrestrial network and reserving resources for the first partial path; and
means for controlling concatenation of the first partial path in the non-terrestrial network with a second partial path for which resources have previously been reserved in the terrestrial network.

### Supplementary Note 2

The control apparatus according to Supplementary Note 1, wherein the response indicates to the first node, the second node, the communication node, the management node, or the other controller that the resource reservation in the non-terrestrial network for the path has been accepted but not yet completed.

### Supplementary Note 3

The control apparatus according to Supplementary Note 1 or 2, wherein
the terrestrial network includes a first terrestrial network between the first node and the non-terrestrial network, and
the response causes completion of a resource reservation for the second partial path in the first terrestrial system network.

### Supplementary Note 4

The control apparatus according to any one of Supplementary Notes 1 to 3, wherein
the terrestrial network includes a second terrestrial network between the non-terrestrial network and the second node, and
the control apparatus further comprises means for transmitting a request for a resource reservation in the second terrestrial network to a node in the second terrestrial network or a controller associated with the second terrestrial network, either directly or through a node in the non-terrestrial network.

### Supplementary Note 5

The control apparatus according to any one of Supplementary Notes 1 to 4, wherein the means for controlling is adapted to instruct one or more nodes in the non-terrestrial network to perform a route switch to concatenate the first partial path with the second partial path.

### Supplementary Note 6

The control apparatus according to any one of Supplementary Notes 1 to 5, wherein the means for controlling is adapted to instruct the first node, the second node, the communication node, the management node, or the other controller, either directly or through a node in the non-terrestrial network, to perform a route switch to concatenate the first partial path with the second partial path.

### Supplementary Note 7

The control apparatus according to any one of Supplementary Notes 1 to 6, wherein the means for controlling is adapted to transmit to the first node, the second node, the communication node, the management node, or the other controller, either directly or through a node in the non-terrestrial network, a notification indicating that the resource reservation for the first partial path has actually been completed or that the first partial path is available.

### Supplementary Note 8

The control apparatus according to Supplementary Note 7, wherein the notification causes a node in the terrestrial network to perform a route switch to concatenate the second partial path in the terrestrial network with the first partial path in the non-terrestrial network.

### Supplementary Note 9

The control apparatus according to any one of Supplementary Notes 1 to 8, wherein the means for controlling is adapted to complete an overall resource reservation for the path by concatenating the first partial path with the second partial path.

### Supplementary Note 10

The control apparatus according to any one of Supplementary Notes 1 to 9, wherein
the request includes a timeliness requirement indicating by when the resources of the path need to be secured, and
the control apparatus further comprises means for determining whether or not to accept the request based on the timeliness requirement.

### Supplementary Note 11

The control apparatus according to Supplementary Note 10, wherein the means for establishing and reserving is adapted to establish the one or more links in the non-terrestrial network and reserve the resources for the first partial path while satisfying the timeliness requirement.

### Supplementary Note 12

A communication node comprising:
at least one memory; and
at least one processor coupled to the at least one memory and configured to:
   transmit a request for a resource reservation for a path from the communication node to another node or from the other node to the communication node that passes through a terrestrial network and a non-terrestrial network, to a node belonging to the path, a first controller associated with the terrestrial network, or a second controller associated with the non-terrestrial network;
   receive a response indicating acceptance of the resource reservation, which is returned without waiting for resources of a first partial path in the non-terrestrial network to actually be reserved for the path; and
   after receiving the response, receive a notification indicating that resource reservation for the path or the first partial path has actually been completed or that the path or the first partial path is available.

### Supplementary Note 13

The communication node according to Supplementary Note 12, wherein the response indicates that resource reservation in the non-terrestrial network for the path has been accepted but not yet completed.

### Supplementary Note 14

The communication node according to Supplementary Note 12 or 13, wherein the request includes a timeliness requirement indicating by when the resources of the path need to be secured.

### Supplementary Note 15

A method performed by a control apparatus, the method comprising:
receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
in response to the request, transmitting a response indicating acceptance of the resource reservation without waiting for resources of a first partial path in the non-terrestrial network to actually be reserved for the path;
establishing one or more links in the non-terrestrial network and reserving resources for the first partial path; and
controlling concatenation of the first partial path in the non-terrestrial network with a second partial path for which resources have previously been reserved in the terrestrial network.

### Supplementary Note 16

A method performed by a communication node, the method comprising:
transmitting a request for a resource reservation for a path from the communication node to another node or from the other node to the communication node that passes through a terrestrial network and a non-terrestrial network, to a node belonging to the path, a first controller associated with the terrestrial network, or a second controller associated with the non-terrestrial network;
receiving a response indicating acceptance of the resource reservation, which is returned without waiting for resources of a first partial path in the non-terrestrial network to actually be reserved for the path; and
after receiving the response, receiving a notification indicating that resource reservation for the path or the first partial path has actually been completed or that the path or the first partial path is available.

### Supplementary Note 17

A program for causing a computer to perform a method for a control apparatus, the method comprising:
receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
in response to the request, transmitting a response indicating acceptance of the resource reservation without waiting for resources of a first partial path in the non-terrestrial network to actually be reserved for the path;
establishing one or more links in the non-terrestrial network and reserving resources for the first partial path; and
controlling concatenation of the first partial path in the non-terrestrial network with a second partial path for which resources have previously been reserved in the terrestrial network.

### Supplementary Note 18

A program for causing a computer to perform a method for a communication node, the method comprising:
transmitting a request for a resource reservation for a path from the communication node to another node or from the other node to the communication node that passes through a terrestrial network and a non-terrestrial network, to a node belonging to the path, a first controller associated with the terrestrial network, or a second controller associated with the non-terrestrial network;
receiving a response indicating acceptance of the resource reservation, which is returned without waiting for resources of a first partial path in the non-terrestrial network to actually be reserved for the path; and
after receiving the response, receiving a notification indicating that resource reservation for the path or the first partial path has actually been completed or that the path or the first partial path is available.

### Supplementary Note 19

A control apparatus comprising:
means for receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
means for transmitting, in response to the request, a response indicating acceptance of the resource reservation without waiting for resources of a first partial path in the non-terrestrial network to actually be reserved for the path; and
means for transmitting a notification to the first node, the second node, the communication node, the management node, the other controller, a communication node in the non-terrestrial network, or any combination thereof, after the resources for the first partial path are actually reserved, wherein
the notification indicates that the resource reservation for the first partial path has actually been completed or that the first partial path is available.

### Supplementary Note 20

The control apparatus according to Supplementary Note 19, wherein the notification causes a node in the terrestrial network to perform a route switch to concatenate the second partial path in the terrestrial network with the first partial path in the non-terrestrial network.

### Supplementary Note 21

A method performed by a control apparatus, the method comprising:
receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
in response to the request, transmitting a response indicating acceptance of the resource reservation without waiting for resources of a first partial path in the non-terrestrial network to actually be reserved for the path; and
transmitting a notification to the first node, the second node, the communication node, the management node, the other controller, a communication node in the non-terrestrial network, or any combination thereof, after the resources for the first partial path are actually reserved, wherein
the notification indicates that the resource reservation for the first partial path has actually been completed or that the first partial path is available.

### Supplementary Note 22

A program for causing a computer to perform a method for a control apparatus, the method comprising:
receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
in response to the request, transmitting a response indicating acceptance of the resource reservation without waiting for resources of a first partial path in the non-terrestrial network to actually be reserved for the path; and
transmitting a notification to the first node, the second node, the communication node, the management node, the other controller, a communication node in the non-terrestrial network, or any combination thereof, after the resources for the first partial path are actually reserved, wherein
the notification indicates that the resource reservation for the first partial path has actually been completed or that the first partial path is available.

1. A control apparatus comprising:
at least one memory; and
at least one processor coupled to the at least one memory and configured to:
receive a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
in response to the request, transmit a response indicating acceptance of the resource reservation without waiting for resources of a first partial path in the non-terrestrial network to actually be reserved for the path;
establish one or more links in the non-terrestrial network and reserve resources for the first partial path; and
control concatenation of the first partial path in the non-terrestrial network with a second partial path for which resources have previously been reserved in the terrestrial network.

2. The control apparatus according to claim 1, wherein the response indicates to the first node, the second node, the communication node, the management node, or the other controller that the resource reservation in the non-terrestrial network for the path has been accepted but not yet completed.

3. The control apparatus according to claim 1, wherein
the terrestrial network includes a first terrestrial network between the first node and the non-terrestrial network, and
the response causes completion of a resource reservation for the second partial path in the first terrestrial system network.

4. The control apparatus according to claim 1, wherein
the terrestrial network includes a second terrestrial network between the non-terrestrial network and the second node, and
the at least one processor is configured to transmit a request for a resource reservation in the second terrestrial network to a node in the second terrestrial network or a controller associated with the second terrestrial network, either directly or through a node in the non-terrestrial network.

5. The control apparatus according to claim 1, wherein the at least one processor is configured to instruct one or more nodes in the non-terrestrial network to perform a route switch to concatenate the first partial path with the second partial path.

6. The control apparatus according to claim 1, wherein the at least one processor is configured to instruct the first node, the second node, the communication node, the management node, or the other controller, either directly or through a node in the non-terrestrial network, to perform a route switch to concatenate the first partial path with the second partial path.

7. The control apparatus according to claim 1, wherein the at least one processor is configured to transmit to the first node, the second node, the communication node, the management node, or the other controller, either directly or through a node in the non-terrestrial network, a notification indicating that the resource reservation for the first partial path has actually been completed or that the first partial path is available.

8. The control apparatus according to claim 7, wherein the notification causes a node in the terrestrial network to perform a route switch to concatenate the second partial path in the terrestrial network with the first partial path in the non-terrestrial network.

9. The control apparatus according to claim 1, wherein the at least one processor is configured to complete an overall resource reservation for the path by concatenating the first partial path with the second partial path.

10. The control apparatus according to claim 1, wherein
the request includes a timeliness requirement indicating by when the resources of the path need to be secured, and
the at least one processor is configured to determine whether or not to accept the request based on the timeliness requirement.

11. The control apparatus according to claim 10, wherein the at least one processor is configured to establish the one or more links in the non-terrestrial network and reserve the resources for the first partial path while satisfying the timeliness requirement.

12. A communication node comprising:
at least one memory; and
at least one processor coupled to the at least one memory and configured to:
transmit a request for a resource reservation for a path from the communication node to another node or from the other node to the communication node that passes through a terrestrial network and a non-terrestrial network, to a node belonging to the path, a first controller associated with the terrestrial network, or a second controller associated with the non-terrestrial network;
receive a response indicating acceptance of the resource reservation, which is returned without waiting for resources of a first partial path in the non-terrestrial network to actually be reserved for the path; and
after receiving the response, receive a notification indicating that resource reservation for the path or the first partial path has actually been completed or that the path or the first partial path is available.

13. The communication node according to claim 12, wherein the response indicates that resource reservation in the non-terrestrial network for the path has been accepted but not yet completed.

14. The communication node according to claim 12, wherein the request includes a timeliness requirement indicating by when the resources of the path need to be secured.

15. A method performed by a control apparatus, the method comprising:
receiving a request for a resource reservation in a non-terrestrial network for a path from a first node to a second node that passes through a terrestrial network and the non-terrestrial network, from the first node, the second node, a communication node belonging to the path, a management node in the non-terrestrial network, or another controller associated with the terrestrial network;
in response to the request, transmitting a response indicating acceptance of the resource reservation without waiting for resources of a first partial path in the non-terrestrial network to actually be reserved for the path;
establishing one or more links in the non-terrestrial network and reserving resources for the first partial path; and
controlling concatenation of the first partial path in the non-terrestrial network with a second partial path for which resources have previously been reserved in the terrestrial network.

16. The method according to claim 15, wherein the response indicates to the first node, the second node, the communication node, the management node, or the other controller that the resource reservation in the non-terrestrial network for the path has been accepted but not yet completed.

17. The method according to claim 15, wherein the controlling comprises instructing one or more nodes in the non-terrestrial network to perform a route switch to concatenate the first partial path with the second partial path.

18. The method according to claim 15, wherein the controlling comprises transmitting to the first node, the second node, the communication node, the management node, or the other controller, either directly or through a node in the non-terrestrial network, a notification indicating that the resource reservation for the first partial path has actually been completed or that the first partial path is available.

19. The method according to claim 18, wherein the notification causes a node in the terrestrial network to perform a route switch to concatenate the second partial path in the terrestrial network with the first partial path in the non-terrestrial network.

20. The method according to claim 15, wherein the controlling comprises completing an overall resource reservation for the path by concatenating the first partial path with the second partial path.
